(19) United States
(12) Patent Application Publication
(10) Pub. No.: US 2026/0261663 A1
(43) Pub. Date: Sep. 3, 2026

(54) ADAPTIVE LOOP FILTER WITH CASCADE FILTERING

(71) Applicant: MEDIATEK INC., Hsinchu City (TW)

(72) Inventors: Shih-Chun CHIU, Hsinchu City (TW); Yu-Ling HSIAO, Hsinchu City (TW); Yu-Cheng LIN, Hsinchu City (TW); Chih-Wei HSU, Hsinchu City (TW); Ching-Yeh CHEN, Hsinchu City (TW); Tzu-Der CHUANG, Hsinchu City (TW); Yi-Wen CHEN, San Jose, CA (US); Yu-Wen HUANG, Hsinchu City (TW)

(21) Appl. No.: 18/994,835

(22) PCT Filed: Aug. 10, 2023
(86) PCT No.: PCT/CN2023/112271

§ 371 Date: Jan. 15, 2025

Related U.S. Application Data
(60) Provisional application No. 63/370,936, filed on Aug. 10, 2022.
(60) Provisional application No. 63/370,938, filed on Aug. 10, 2022.

(51) Int. Cl. H04N 19/117; H04N 19/105; H04N 19/176; H04N 19/82

(52) U.S. Cl. CPC H04N 19/117; H04N 19/105; H04N 19/176; H04N 19/82

(57) ABSTRACT

A method for performing cascade filtering in an adaptive loop filter (ALF) of a video coder is provided. The video coder receives a current sample at a current pixel position of a current picture of a video. The video coder applies first filter comprising a plurality of filter taps. The current sample and neighboring samples taken from pixel positions near the current sample are used as tap inputs to the plurality of filter taps of the first filter. The video coder applies a second filter comprising at least one filter tap. A first output of the first filter is used to generate a tap input to the at least one filter tap of the second filter. The video coder updates the current sample based on a second output of the second filter. The video coder reconstructs the current picture based on the updated current sample.

### CROSS REFERENCE TO RELATED PATENT APPLICATION(S)

The present disclosure is part of a non-provisional application that claims the priority benefit of U.S. Provisional Patent Application Nos. 63/370,936 and 63/370,938, both filed on 10 Aug. 2022. Contents of above-listed applications are herein incorporated by reference.

### TECHNICAL FIELD

The present disclosure relates generally to video coding. In particular, the present disclosure relates to methods of coding video pictures by using an adaptive loop filter.

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs).

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). The leaf nodes of a coding tree correspond to the coding units (CUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical center-side triple-tree partitioning, horizontal center-side triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one-color component associated with CTU, CU, PU, and TU, respectively. Thus, a CTU consists of one luma CTB, two chroma CTBs, and associated syntax elements. A similar relationship is valid for CU, PU, and TU.

For each inter-predicted CU, motion parameters consisting of motion vectors, reference picture indices and reference picture list usage index, and additional information are used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list and reference picture list usage flag and other needed information are signalled explicitly per each CU.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide a method for performing cascade filtering in an adaptive loop filter (ALF) of a video coder. The video coder receives a current sample at a current pixel position of a current picture of a video. The video coder applies first filter comprising a plurality of filter taps. The current sample and neighboring samples taken from pixel positions near the current sample are used as tap inputs to the plurality of filter taps of the first filter. The plurality of filter taps of the first filter may use differences between the current sample and the neighboring samples as tap input.

The video coder applies a second filter comprising at least one filter tap. A first output of the first filter is used to generate a tap input to the at least one filter tap of the second filter. The video coder updates the current sample based on a second output of the second filter. The video coder reconstructs the current picture based on the updated current sample.

In some embodiments, the video coder receives or signals a particular flag for enabling or disabling cascade filtering. When the particular flag enables cascade filtering, the output of the second filter is used to update the current sample. When the particular flag disables cascade filtering, the output of the first filter is used to update the current sample. In some embodiments, the second filter is applied only when a difference between the current sample and the first output of the first filter is not zero. In some embodiments, the second filter is applied only when a difference between the current sample and the first output of the first filter is zero. In some embodiments, the second filter is applied only when a difference between the current sample and the first output of the first filter is greater than a threshold. In some embodiments, the second filter is applied only when a difference between the current sample and the first output of the first filter is less than a threshold.

In some embodiments, the tap input of the at least one filter tap of the second filter is a clipped difference between the first output and the current sample. In some embodiments, the second filter further includes a plurality of filter taps that use differences between the current sample and the neighboring samples as tap inputs. The plurality of filter taps of the second filter may have filter coefficients that are different than or the same as that of the first filter.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIGS. 1A-B illustrate two diamond filter shapes for Adaptive Loop Filters (ALF).

FIG. 2 illustrates a system level diagram of loop filters.

FIG. 3 illustrates filtering in cross-component ALF (CC-ALF).

FIG. 4 conceptually illustrates a current sample and its neighboring samples that are used as filter tap inputs for filtering the current sample.

FIG. 5 conceptually illustrates a cascade filter in which the filtering result of a first filter set is used as a filtering tap of a second filter set.

FIG. 6 conceptually illustrates a cascaded filter in which a first filtering result is modified by an additional filter tap with the difference between the current sample and the result of the first filtering as tap input.

FIG. 7 conceptually illustrates a two-stage ALF, in which the filter coefficients of the first stage are different from the filter coefficients of the second stage.

FIG. 8 illustrates an example video encoder that implements ALF.

FIG. 9 illustrates portions of the video encoder that implement ALF with multiple stages or cascade filtering.

FIG. 10 conceptually illustrates a process for performing cascade filtering in ALF.

FIG. 11 illustrates an example video decoder that implement ALF.

FIG. 12 illustrates portions of the video decoder that implement ALF with multiple stages or cascade filtering.

FIG. 13 conceptually illustrates a process for performing cascade filtering in ALF.

FIG. 14 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Adaptive Loop Filter

### A. Filter Shape

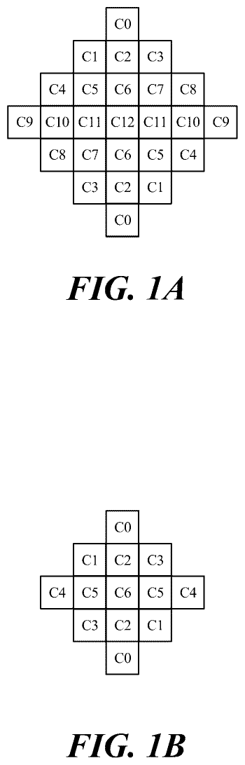

Adaptive Loop Filter (ALF) is an in-loop filtering technique used in video coding standards such as VVC. It is a block-based filter that minimizes the mean square error between original and reconstructed samples. For the luma component, one among 25 filters is selected for each 4×4 block, based on the direction and activity of local gradients. FIGS. 1A-B illustrate two diamond filter shapes for Adaptive Loop Filters (ALF). Each position in a diamond correspond to a filter tap having a filter coefficient. FIG. 1A shows a 7×7 diamond shape having taps with filter coefficients C0-C12 that is applied for luma component. FIG. 1B shows a 5×5 diamond shape with filter coefficients C0-C6 that is applied for chroma components.

### B. Block Classification

For luma component, each 4×4 block is categorized into one out of 25 classes. The classification index C is derived based on its directionality D and a quantized value of activity Â according to the following:

$$C = 5 D + \hat{A}$$

To calculate D and Â, gradients of the horizontal, vertical and two diagonal directions are first calculated using 1-D Laplacian:

$${g}_{v} = {{\sum }_{k = i - 2}}^{i + 3} {{\sum }_{l = j - 2}}^{j + 3} {V}_{k , l} , {V}_{k , l} = \vert 2 R ( k , l ) - R ( k , l - 1 ) - R ( k , l + 1 ) \vert$$

$${g}_{h} = {{\sum }_{k = i - 2}}^{i + 3} {{\sum }_{l = j - 2}}^{j + 3} {H}_{k , l} , {H}_{k , l} = \vert 2 R ( k , l ) - R ( k - 1 , l ) - R ( k + 1 , l ) \vert$$

$${g}_{d 1} = {{\sum }_{k = i - 2}}^{i + 3} {{\sum }_{l = j - 2}}^{j + 3} D {1}_{k , l} , D {1}_{k , l} = \vert 2 R ( k , l ) - R ( k - 1 , l - 1 ) - R ( k + 1 , l + 1 ) \vert$$

$${g}_{d 2} = {{\sum }_{k = i - 2}}^{i + 3} {{\sum }_{l = j - 2}}^{j + 3} D {2}_{k , l} , D {2}_{k , l} = \vert 2 R ( k , l ) - R ( k - 1 , l + 1 ) - R ( k + 1 , l - 1 ) \vert$$

Where indices i and j refer to the coordinates of the upper left sample within the 4×4 block and R(i,j) indicates a reconstructed sample at coordinate (i,j). To reduce the complexity of block classification, the subsampled 1-D Laplacian calculation is applied. The same subsampled positions may be used for gradient calculation of all directions. (The subsampled positions may be for vertical gradient, horizontal gradient, or diagonal gradient.) The D maximum and minimum values of the gradients of horizontal and vertical directions are set as:

$${g}_{h , v}^{max} = max ( {g}_{h} , {g}_{v} )$$

$${g}_{h , v}^{min} = min ( {g}_{h} , {g}_{v} )$$

The maximum and minimum values of the gradient of two diagonal directions are set as:

$${g}_{d 0 , d 1}^{max} = max ( {g}_{d 0} , {g}_{d 1} ) ,$$

$${g}_{d 0 , d 1}^{min} = min ( {g}_{d 0} , {g}_{d 1} )$$

To derive the value of the directionality D, these values are compared against each other and with two thresholds t₁ and t₂:

Step 1. If both

$${g}_{h , v}^{max} \leq {t}_{1} \cdot {g}_{h , v}^{min} and {g}_{d 0 , d 1}^{max} \leq {t}_{1} \cdot {g}_{d 0 , d 1}^{min}$$

are true, D is set to 0.

Step 2. If

$${g}_{h , v}^{max} / {g}_{h , v}^{min} > {g}_{d 0 , d 1}^{max} {/}_{d 0 , d 1}^{min} ,$$

continue from Step 3; otherwise continue from Step 4.

Step 3. If

$${g}_{h , v}^{max} > {t}_{2} \cdot {g}_{h , v}^{min} ,$$

D is set to 2; otherwise D is set to 1.

Step 4. If

$${g}_{d 0 , d 1}^{max} > {t}_{2} \cdot {g}_{d 0 , d 1}^{min} ,$$

D is set to 4; otherwise D is set to 3.

The activity value A is calculated as:

$$A = {{\sum }_{k = i - 2}}^{i + 3} {{\sum }_{l = j - 2}}^{j + 3} ( {V}_{k , l} + {H}_{k , l} )$$

A is further quantized to the range of 0 to 4, inclusively, and the quantized value is denoted as Â. For chroma components in a picture, no classification method is applied.

### C. Geometric Transformation of Filter Coefficients and Clipping Values

Before filtering each 4×4 luma block, geometric transformations such as rotation or diagonal and vertical flipping are applied to the filter coefficients f (k,l) and to the corresponding filter clipping values c (k,l) depending on gradient values calculated for that block. This is equivalent to applying these transformations to the samples in the filter support region. The idea is to make different blocks to which ALF is applied more similar by aligning their directionality. There are three geometric transformations, including diagonal, vertical flip and rotation are introduced:

$$Diagonal : {f}_{D} ( k , l ) = f ( l , k ) , {c}_{D} ( k , l ) = c ( l , k ) ,$$

$$Vertical flip : {f}_{V} ( k , l ) = f ( k , K - l - 1 ) , {c}_{V} ( k , l ) = c ( k , K - l - 1 )$$

$$Rotation : {f}_{R} ( k , l ) = f ( K - l - 1 , k ) , {c}_{R} ( k , l ) = c ( K - l - 1 , k )$$

where K is the size of the filter and 0≤k, 1≤K−1 are coefficients coordinates, such that location (0,0) is at the upper left corner and location (K−1, K−1) is at the lower right corner. The transformations are applied to the filter coefficients f (k,l) and to the clipping values c(k,l) depending on gradient values calculated for that block. The relationship between the transformation and the four gradients of the four directions are summarized in Table 1 below that shows Mapping of the gradient calculated for one block and transformation.

TABLE 1

| Gradient values | Transformation |
|---|---|
| g_{d2} < g_{d1} and gₕ < gᵥ | No transformation |
| g_{d2} < g_{d1} and gᵥ < gₕ | Diagonal |
| g_{d1} < g_{d1} and gₕ < gᵥ | Vertical flip |
| g_{d1} < g_{d2} and gᵥ < gₕ | Rotation |

### D. Filtering Process

At decoder side, when ALF is enabled for a CTB, each sample R′(i,j) within the CU is filtered, resulting in sample value R′(i,j) as shown below:

$${R}^{′} ( i , j ) = R ( i , j ) + ( ( {\sum }_{k \neq 0} {\sum }_{l \neq 0} f ( k , l ) \times K ( R ( i + k , j + l ) - R ( i , j ) , c ( k , l ) ) + 64 ) ≫ 7 )$$

where f(k,l) denotes the decoded filter coefficients, K (x, y) is the clipping function and c(k,l) denotes the decoded clipping parameters. The variable k and/vary between −L/2 and L/2, wherein L denotes the filter length. The clipping function K (x, y)=min(y, max(−y, x)) which corresponds to the function Clip3 (−y, y, x). The clipping operation introduces non-linearity to make ALF more efficient by reducing the impact of neighbor sample values that are too different with the current sample value.

### E. Cross Component Adaptive Loop Filter (CC-ALF)

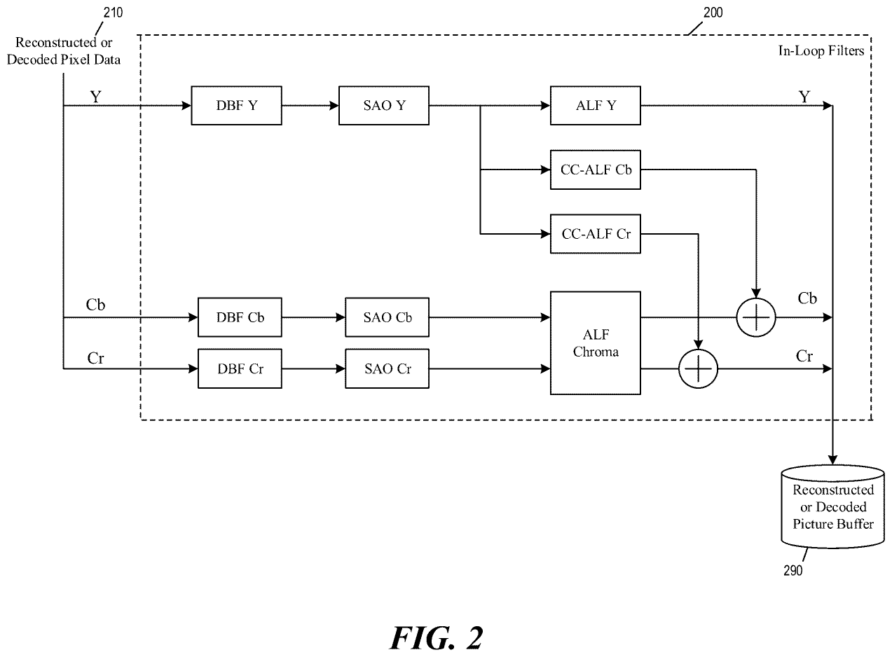

CC-ALF may use luma sample values to refine each chroma component by applying an adaptive, linear filter to the luma channel and then using the output of this filtering operation for chroma refinement. FIG. 2 illustrates a system level diagram of loop filters 200, in which reconstructed or decoded samples 210 are filtered or processed by deblock filter (DBF), sample adaptive offset (SAO), and adaptive filter (ALF). The reconstructed or decoded samples 210 may be generated from prediction signals and residual signals of the current block.

The figure shows placement of CC-ALF with respect to other loop filters. Specifically, the luma component of the SAO output is processed by a luma ALF process (ALF Y) and a pair of cross-component ALF processes (CC-ALF Cb and CC-ALF Cr). The two cross-component ALF processes generate cross-component offset for Cb and Cb components to be added to the output of a chroma ALF process (ALF chroma) to generate ALF output for the chroma components. The luma and chroma components of the ALF output are then stored in a reconstructed or decoded picture buffer 290 to be used for predictive coding of subsequent pixel blocks.

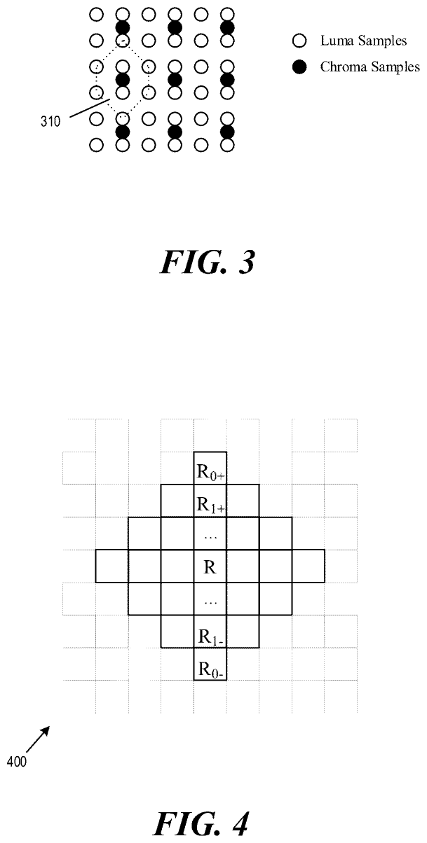

FIG. 3 illustrates filtering in cross-component ALF (CC-ALF), which is accomplished by applying a linear, diamond shaped filter 310 to the luma channel. One filter is used for each chroma channel, and the operation is expressed as

$$Δ {I}_{i} ( x , y ) = {\sum }_{( {x}_{0} , {y}_{0} ) ∈ {S}_{i}} {I}_{0} ( {x}_{Y} + {x}_{0} , {y}_{Y} + {y}_{0} ) {c}_{i} ( {x}_{0} , {y}_{0} )$$

where (x, y) is chroma component i location being refined (x_{Y}, y_{Y}) is the luma location based on (x, y), Sᵢ is filter support area in luma component, cᵢ(x₀,y₀) represents the filter coefficients. As shown in FIG. 3, the luma filter support is the region collocated with the current chroma sample after accounting for the spatial scaling factor between the luma and chroma planes.

CC-ALF filter coefficients may be computed by minimizing the mean square error of each chroma channels with respect to the original chroma content. To achieve this, an algorithm may use a coefficient derivation process similar to the one used for chroma ALF. Specifically, a correlation matrix is derived, and the coefficients are computed using a Cholesky decomposition solver in an attempt to minimize a mean square error metric. In designing the filters, a maximum of 8 CC-ALF filters can be designed and transmitted per picture. The resulting filters are then indicated for each of the two chroma channels on a CTU basis.

CC-ALF filtering may use a 3×4 diamond shape with 8 filter taps, with 7 filter coefficients transmitted in the APS (may be referenced in the slice header). Each of the transmitted coefficients has a 6-bit dynamic range and is restricted to power-of-2 values. The 8th filter coefficient is derived at the decoder such that the sum of the filter coefficients is equal to 0. CC-ALF filter selection may be controlled at CTU-level for each chroma component. Boundary padding for the horizontal virtual boundaries may the same memory access pattern as luma ALF.

As an additional feature, the reference encoder can be configured to enable some basic subjective tuning through the configuration file. When enabled, the VTM attenuates the application of CC-ALF in regions that are coded with high quantization parameter (QP) and are either near mid-grey or contain a large amount of luma high frequencies. Algorithmically, this is accomplished by disabling the application of CC-ALF in CTUs where any of the following conditions are true:
(i) The slice QP value minus 1 is less than or equal to the base QP value
(ii) The number of chroma samples for which the local contrast is greater than (1<<(bitDepth−2))−1 exceeds the CTU height, where the local contrast is the difference between the maximum and minimum luma sample values within the filter support region
(iii) More than a quarter of chroma samples are in the range between (1<<(bitDepth−1))−16 and (1<<(bitDepth−1))+16

This is for providing some assurance that CC-ALF does not amplify artifacts introduced earlier in the decoding path.

### F. Filter Parameter Signaling

ALF filter parameters may be signalled in Adaptation Parameter Set (APS). In one APS, up to 25 sets of luma filter coefficients and clipping value indexes, and up to eight sets of chroma filter coefficients and clipping value indexes could be signalled. To reduce bits overhead, filter coefficients of different classification for luma component can be merged. In slice header, the indices of the APSs used for the current slice are signaled.

Clipping value indexes, which are decoded from the APS, allow determining clipping values using a table of clipping values for both luma and Chroma components. These clipping values are dependent of the internal bit-depth. More precisely, the clipping values are obtained by the following formula:

$$ALFClip = \{ round ( {2}^{B - α * n} ) for n ∈ [ 0 … N - 1 ] \}$$

with B equal to the internal bit-depth, a is a pre-defined constant value equal to 2.35, and N equal to 4 which is the number of allowed clipping values in VVC. The ALFClip is then rounded to the nearest value with the format of power of 2.

In slice header, up to 7 APS indices can be signaled to specify the luma filter sets that are used for the current slice. The filtering process can be further controlled at CTB level. A flag is always signalled to indicate whether ALF is applied to a luma CTB. Aluma CTB can choose a filter set among 16 fixed filter sets and the filter sets from APSs. A filter set index is signaled for a luma CTB to indicate which filter set is applied. The 16 fixed filter sets are pre-defined and hard-coded in both the encoder and the decoder.

For chroma components, an APS index may be signaled in slice header to indicate the chroma filter sets being used for the current slice. At CTB level, a filter index is signaled for each chroma CTB if there is more than one chroma filter set in the APS. The filter coefficients are quantized with norm equal to 128. In order to restrict the multiplication complexity, a bitstream conformance is applied so that the coefficient value of the non-central position shall be in the range of −2⁷ to 2⁷−1, inclusive. The central position coefficient is not signalled in the bitstream and is considered as equal to 128.

G. ALF Simplification with Filtering by Fixed Filters

In some embodiments, ALF gradient subsampling and ALF virtual boundary processing are removed. Block size for classification is reduced from 4×4 to 2×2. Filter size for both luma and chroma, for which ALF coefficients are signalled, is increased to 9×9.

To filter a luma sample, three different classifiers (C₀, C₁ and C₂) and three different sets of filters (F₀, F₁ and F₂) may be used. Sets F₀ and F₁ contain fixed filters, with coefficients trained for classifiers C₀ and C₁. Coefficients of filters in F₂ are signaled. Which filter from a set Fᵢ is used for a given sample is decided by a class Cᵢ assigned to this sample using classifier Cᵢ. At first, two 13×13 diamond shape fixed filters F₀ and F₁ are applied to derive two intermediate samples R₀(x, y) and R₁(x, y). After that, F₂ is applied to R₀(x, y) and R₁(x, y) and neighboring samples to derive a filtered sample as:

$$\tilde{R} ( x , y ) = R ( x , y ) + [ {{\sum }_{i = 0}}^{16} {c}_{i} ( {f}_{i , 0} + {f}_{i , 1} ) ] + [ {{\sum }_{i = 20}}^{21} {c}_{i} {g}_{i} ] \qquad ( 1 )$$

where f_{i,j} is the clipped difference between a neighboring sample and current sample R(x, y) and gᵢ is the clipped difference between Rᵢ₋₂₀ (x, y) and the current sample. The filter coefficients cᵢ, i=0, . . . 21, are signaled.

FIG. 4 conceptually illustrates a current sample and its neighboring samples that are used as filter tap inputs for filtering the current sample. The figure illustrates a portion of a current picture 400. The current sample is shown at the center and labeled ‘R’, and the neighboring samples used to generate the filter tap inputs are labeled R₀₊, R₀₋, R₁₊, R₁₋, etc. Adaptive loop filtering (ALF) is performed based on the filtered tap inputs to produce the filtered output \tilde{R} for the current sample by using e.g., Eq. (1) above.

Based on directionality Dᵢ and activity Âᵢ, a class Cᵢ is assigned to each 2×2 block:

$${C}_{i} = {\hat{A}}_{i} * {M}_{D , i} + {D}_{i} \qquad ( 2 )$$

where M_{D,i} represents the total number of directionalities Dᵢ. The values of the horizontal, vertical, and two diagonal gradients may be calculated for each sample using 1-D Laplacian. The sum of the sample gradients within a 4×4 window that covers the target 2×2 block is used for classifier C₀ and the sum of sample gradients within a 12×12 window is used for classifiers C₁ and C₂. The sums of horizontal, vertical and two diagonal gradients are denoted, respectively, as

$${g}_{h}^{i} , {g}_{v}^{i} , {g}_{d 1}^{i} and {g}_{d 2}^{i} .$$

The directionality Dᵢ is determined by comparing:

$${r}_{h , v}^{i} = \frac{max ( {g}_{h}^{i} , {g}_{v}^{i} )}{min ( {g}_{h}^{i} , {g}_{v}^{i} )} , {r}_{d 1 , d 2}^{i} = \frac{max ( {g}_{d 1}^{i} , {g}_{d 2}^{i} )}{min ( {g}_{d 1}^{i} , {g}_{d 2}^{i} )} \qquad ( 3 )$$

with a set of thresholds. The directionality D₂ is derived using thresholds 2 and 4.5. For D₀ and D₁, horizontal/vertical edge strength

$${E}_{H V}^{i}$$

and diagonal edge strength

$${E}_{D}^{i}$$

are calculate first Thresholds Th=[1.25, 1.5, 2, 3, 4, 5, 8] are used. Edge strength

$${E}_{H V}^{i}$$

is 0 if

$${r}_{h , v}^{i} \leq Th [ 0 ] ;$$

otherwise,

$${E}_{H V}^{i}$$

is the maximum integer such that

$${r}_{h , v}^{i} > T h [ {E}_{H V}^{i} - 1 ] .$$

Edge strength

$${E}_{D}^{i}$$

is 0 if

$${r}_{d 1 , d 2}^{i} \leq T h [ 0 ] ;$$

otherwise,

$${E}_{D}^{i}$$

is the maximum integer such that

$${r}_{d 1 , d 2}^{i} > T h [ {E}_{D}^{i} - 1 ] .$$

Table 2(a) and Table 2(b) below show Mapping of E′_{D} and E′_{HV} to Di. When

$${r}_{h , v}^{i} > {r}_{d 1 , d 2}^{i} ,$$

i.e., horizontal/vertical edges are dominant, Dᵢ is derived by using Table 2(a) below. Otherwise, diagonal edges are dominant, and Dᵢ is derived by using Table 2(b).

TABLE 2(a)

E_{D}ⁱ

| E_{HV}ⁱ | 0 | 1 | 2 | 3 | 4 | 5 | 6 |
|---|---|---|---|---|---|---|---|
| 0 | 0 | 0 | 0 | 0 | 0 | 0 | 0 |
| 1 | 1 | 2 | 0 | 0 | 0 | 0 | 0 |
| 2 | 3 | 4 | 5 | 0 | 0 | 0 | 0 |
| 3 | 6 | 7 | 8 | 9 | 0 | 0 | 0 |
| 4 | 10 | 11 | 12 | 13 | 14 | 0 | 0 |
| 5 | 15 | 16 | 17 | 18 | 19 | 20 | 0 |
| 6 | 21 | 22 | 23 | 24 | 25 | 26 | 27 |

TABLE 2(b)

E_{HV}ⁱ

| E_{D}ⁱ | 0 | 1 | 2 | 3 | 4 | 5 | 6 |
|---|---|---|---|---|---|---|---|
| 0 | 28 | 0 | 0 | 0 | 0 | 0 | 0 |
| 1 | 29 | 30 | 0 | 0 | 0 | 0 | 0 |
| 2 | 31 | 32 | 33 | 0 | 0 | 0 | 0 |
| 3 | 34 | 35 | 36 | 37 | 0 | 0 | 0 |
| 4 | 38 | 39 | 40 | 41 | 42 | 0 | 0 |
| 5 | 43 | 44 | 45 | 46 | 47 | 48 | 0 |
| 6 | 49 | 50 | 51 | 52 | 53 | 54 | 55 |

To obtain activity Âᵢ, the sum of vertical and horizontal gradients Aᵢ is mapped to the range of 0 to n, where n is equal to 4 for Â₂ and 15 for Â₀ and Â₁. In an ALF_APS, up to 4 luma filter sets are signalled, each set may have up to 25 filters.

### II. Joint Coding of Chroma Residuals (JCCR)

Joint coding of chroma residual (JCCR) is a video coding tool by which the chroma residuals are coded jointly. The usage (activation) of the JCCR mode may be indicated by a TU-level flag tu_joint_cbcr_residual_flag and the selected mode is implicitly indicated by the chroma CBFs. The flag tu_joint_cbcr_residual_flag is present if either or both chroma CBFs for a TU are equal to 1. In the picture parameter set (PPS) and slice header, chroma quantization parameter (QP) offset values are signalled for the JCCR mode to differentiate from the usual chroma QP offset values signalled for regular chroma residual coding mode. These chroma QP offset values are used to derive the chroma QP values for some blocks coded using the JCCR mode. The JCCR mode has 3 sub-modes, as detailed in Table 3 below, which shows reconstruction of chroma residuals.

TABLE 3
sub-modes of JCCR

| tu_cbf_cb | tu_cbf_cr | reconstruction of Cb and Cr residuals | mode |
|---|---|---|---|
| 1 | 0 | resCb[x][y] = resJointC[x][y] | 1 |
| | | resCr[x][y] = (CSign * resJointC[x][y]) >> 1 | |
| 1 | 1 | resCb[x][y] = resJointC[x][y] | 2 |
| | | resCr[x][y] = CSign * resJointC[x][y] | |
| 0 | 1 | resCb[x][y] = (CSign * resJointC[x][y]) >> 1 | 3 |
| | | resCr[x][y] = resJointC[x][y] | |

The value CSign is a sign value (+1 or −1), which is specified in the slice header, resJointC[ ][ ] is the transmitted residual. When JCCR sub-mode 2 is active in a TU, the chroma QP offset is added to the applied luma-derived chroma QP during quantization and decoding of that TU. For the other JCCR sub-modes (sub-modes 1 and 3), the chroma QPs are derived in the same way as for conventional Cb or Cr blocks. The reconstruction process of the chroma residuals (resCb and resCr) from the transmitted transform blocks is depicted in Table 3. When the JCCR mode is activated, one single joint chroma residual block (resJointC[x][y]) is signalled, and residual block for Cb (resCb) and residual block for Cr (resCr) are derived considering information such as tu_cbf_cb, tu_cbf_cr, and CSign, which is a sign value specified in the slice header.

At the encoder side, the joint chroma components are derived, depending on the JCCR sub-mode, resJointC{1,2} are generated by the encoder as follows:
If mode is equal to 2 (single residual with reconstruction Cb=C, Cr=CSign*C), the joint residual is determined according to

$$resJointC [ x ] [ y ] = resCb [ x ] [ y ] + CSign * resCr [ x ] [ y ] / 2$$

Otherwise, if mode is equal to 1 (single residual with reconstruction Cb=C, Cr=(CSign*C)/2), the joint residual is determined according to

$$resJointC [ x ] [ y ] = ( 4 * resCb [ x ] [ y ] + 2 * resCr [ x ] [ y ] ) / 5$$

Otherwise (mode is equal to 3, i. e., single residual, reconstruction Cr=C, Cb=(CSign*C)/2), the joint residual is determined according to

$$resJointC [ x ] [ y ] = ( 4 * resCr [ x ] [ y ] + 2 * CSign * resCb [ x ] [ y ] ) / 5$$

In some embodiments, the three joint chroma coding sub-modes described above in Table 3 are only supported in I slices. In P and B slices, only mode 2 is supported. Hence, in P and B slices, the syntax element tu_joint_cbcr_residual_flag is only present if both chroma cbfs are 1.

The JCCR mode can be combined with the chroma transform skip (TS) mode. To speed up the encoder decision, the JCCR transform selection may depend on whether the independent coding of Cb and Cr components selects the DCT-2 or the TS as the best transform, and whether there are non-zero coefficients in independent chroma coding. Specifically, if one chroma component selects DCT-2 (or TS) and the other component is all zero, or both chroma components select DCT-2 (or TS), then only DCT-2 (or TS) will be considered in JCCR encoding. Otherwise, if one component selects DCT-2 and the other selects TS, then both DCT-2 and TS will be considered in JCCR encoding.

III. ALF with Joint Chroma Filters

The video coder may select the best filters for Cb and Cr CTBs separately. Some embodiments of the disclosure provide a joint chroma filtering design, in which the filtering process of one component is associated with that of the other component through a predetermined model. The use of the predetermined model removes CTB-level filter selection signaling for one component.

In some embodiments, one APS-level flag is signaled to indicate whether to use joint chroma filtering or not. If joint chroma filtering is used, correction value generated by Cb filter is also applied to Cr through a predetermined linear model according to the following:

$$Cb reconstruction \text{:} {\tilde{R}}_{Cb} = {R}_{Cb} + [ {\sum }_{i = 0}^{19} {c}_{i , cb} ( {f}_{i , 0 , cb} + {f}_{i , 1 , cb} ) ] = {R}_{Cb} + Δ {R}_{Cb} \qquad ( 4 )$$

$$Cr reconstruction \text{:} {\tilde{R}}_{Cr} = {R}_{Cr} + m Δ {R}_{Cb}$$

where m is a predefined number to model the relationship between Cb and Cr reconstruction. In some embodiments, additional APS-level flags are signaled to indicate the value of m. In some embodiments, such joint chroma filtering flags are signaled at slice level. In some embodiments, one APS-level flag is signaled to indicate whether to use joint chroma filtering or not. If joint chroma filtering is used, filter selected for Cb is also applied to Cr through a predetermined linear model according to the following:

$$Cb reconstruction \text{:} {\tilde{R}}_{Cb} = {R}_{Cb} + [ {\sum }_{i = 0}^{19} {c}_{i , cb} ( {f}_{i , 0 , cb} + {f}_{i , 1 , cb} ) ] \qquad ( 5 )$$

$$Cr reconstruction \text{:} {\tilde{R}}_{Cr} = {R}_{Cr} + m [ {\sum }_{i = 0}^{19} {c}_{i , cb} ( {f}_{i , 0 , cr} + {f}_{i , 1 , cr} ) ] ,$$

where m is a predefined number to model the relationship between an r reconstruction. The filter coefficients c_{i,cb} (with i=0, 1, . . . , 19) may be shared for both components (Cr and Cb). In some embodiments, additional APS-level flags are signaled to indicate the value of m. In some embodiments, such joint chroma filtering flags are signaled at slice level. In some embodiments, the value of m is determined by Cb or Cr classification results (e.g., a class map to a m value.) In some embodiments, a predetermined linear model may also be applied to Cb shown as follows.

$$Cb reconstruction \text{:} {\tilde{R}}_{Cb} = {R}_{Cb} + m Δ {R}_{Cr} \qquad ( 6 )$$

$$Cr reconstruction \text{:} {\tilde{R}}_{Cr} = {R}_{Cr} + Δ {R}_{Cr}$$

$$or$$

$$Cb reconstruction \text{:} {\tilde{R}}_{Cb} = {R}_{Cb} + m [ {\sum }_{i = 0}^{19} {c}_{i , cr} ( {f}_{i , 0 , cb} + {f}_{i , 1 , cb} ) ]$$

$$Cr reconstruction \text{:} {\tilde{R}}_{Cr} = {R}_{Cr} + [ {\sum }_{i = 0}^{19} {c}_{i , cr} ( {f}_{i , 0 , cr} + {f}_{i , 1 , cr} ) ] ,$$

In some embodiments, the joint chroma filtering concept can be applied to chroma ALF and CCALF. In CCALF case, (f_{i,0,cb}+f_{i,j,cb}) and (f_{i,0,cr}+f_{i,j,cr}) in the above equations are replaced with f_{i,y}, which represents a corresponding neighboring difference of luma component.

In some embodiments, classification is also performed for the chroma components, where the class indices of Cb and Cr are non-overlapped. For example, the video coder may classify Cb into classes 0 through 4 and classify Cr into classes 5 through 9. The classification is performed based on chroma sample values only, corresponding luma sample values only, or both luma and chroma sample values. The video coder may apply chroma classification to chroma ALF as well as to CCALF.

IV. ALF with Cascade Filtering

Some embodiments of the disclosure provide methods of cascade filtering. One APS-level flag may be signaled to indicate whether cascade filtering is used or not. In some embodiments, cascaded filtering is implemented by using fixed filtering results as additional filter taps of APS filters for luma component. In some embodiments, filtering result of a first APS filter set is used as a filtering tap of a second APS filter set. In some embodiments, for the filters in the first filter set, the filtering equation can be written as:

$${\tilde{R}}_{1} = R + [ {\sum }_{i = 0}^{19} {c}_{i} ( {f}_{i , 0} + {f}_{i , 1} ) ] + [ {\sum }_{i = 20}^{21} {c}_{i} {g}_{i} ] \qquad ( 7 )$$

where f_{i,j} is the clipped difference between a neighboring sample and current sample R, gᵢ is the clipped difference between the current sample before and after the filtering of one fixed filter set, and cᵢ (with i=0, 1, . . . , 21) are filter coefficients. For the filters in the second filter set, the filtering equation can be written as:

$${\tilde{R}}_{2} = R + [ {\sum }_{i = 0}^{19} {c}_{i} ( {f}_{i , 0} + {f}_{i , 1} ) ] + [ {\sum }_{i = 20}^{21} {c}_{i} {g}_{i} ] + {c}_{22} Clip ( {\tilde{R}}_{1} - R ) \qquad ( 8 )$$

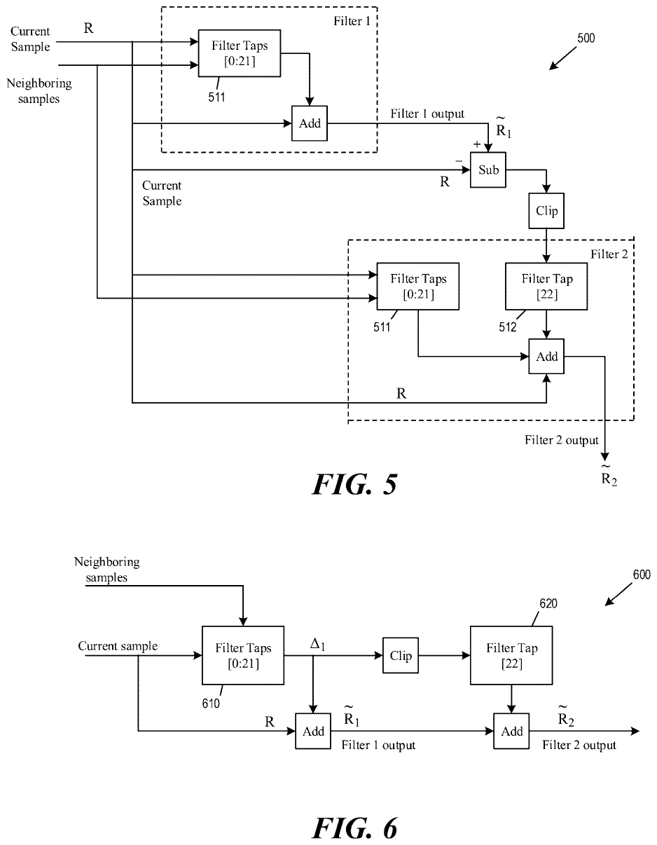

FIG. 5 conceptually illustrates a cascade filter 500 in which the filtering result of a first APS filter set is used as a filtering tap of a second APS filter set. The cascade filter 500 is an ALF that includes filter tap modules 511 and 512. The filter tap module 511 (“Filter Taps [0:21]) correspond to computing

$$[ {\sum }_{i = 0}^{19} {c}_{i} ( {f}_{i , 0} + {f}_{i , 1} ) ] + [ {\sum }_{i = 20}^{21} {c}_{i} {g}_{i} ] .$$

The filter tap module 512 (“Filter Tap [22]”) corresponds to computing c₂₂Clip(\tilde{R}₁−R).

If there are more than two filter sets in the APS, then the filtering of the N-th filter set is based on the filtering result of the (N−1)-th filter set similar to the equations shown above.

In Eq. (8), the filtering result of the first APS filter set \tilde{R}₁ is used as a filtering tap of the second APS filter set. More precisely, a difference Δ₁=\tilde{R}₁−R between the current sample R and the result of the first filtering is clipped and used as an input for an additional filtering tap (c₂₂) of the second APS filter set. However, according to Eq. (7),

$${Δ}_{1} = {\tilde{R}}_{1} - R = [ {\sum }_{i = 0}^{19} {c}_{i} ( {f}_{i , 0} + {f}_{i , 1} ) ] + [ {\sum }_{i = 20}^{21} {c}_{i} {g}_{i} ] \qquad ( 9 )$$

The coefficients (c₀ through c₂₁) of the first and second APS filter sets can be different or identical. If the coefficients (c₀ through c₂₁) of the first and second APS filter sets are identical, then the Eq. (8) can be re-written as

$${\tilde{R}}_{2} = R + {Δ}_{1} + {c}_{22} Clip ( {Δ}_{1} ) \qquad ( 10 )$$

$$Since {Δ}_{1} = {\tilde{R}}_{1} - R , so {\tilde{R}}_{1} = R + {Δ}_{1} , and Eq . ( 10 ) can be re - written as : {\tilde{R}}_{2} = {\tilde{R}}_{1} + {c}_{22} Clip ( {Δ}_{1} ) \qquad ( 11 )$$

Thus, the cascaded filter can be described as modifying the result of the first APS filter \tilde{R}₁ by an additional filter tap with the difference between the current sample and the result of the first filtering as tap input. FIG. 6 conceptually illustrates a cascaded filter 600 in which a first filtering result is modified by an additional filter tap with the difference between the current sample and the result of the first filtering as tap input. The cascade filter 600 is an ALF that includes a filter tap module 610 and a filter tap module 620. The first filter tap module 610 (“Filter Taps [0:21]) correspond to computing Δ₁, or

$$[ {\sum }_{i = 0}^{19} {c}_{i} ( {f}_{i , 0} + {f}_{i , 1} ) ] + [ {\sum }_{i = 20}^{21} {c}_{i} {g}_{i} ] .$$

The second filter tap module 620 (“Filter Tap[22]”) correspond to computing c₂₂Clip(A₁) or c₂₂Clip(\tilde{R}₁−R).

In some embodiments, for the filters in the second filter set, the filtering equation can be written as:

$${\tilde{R}}_{2} = R + [ \text{} {\sum }_{i = 0}^{19} {c}_{i} ( {f}_{i , 0} + {f}_{i , 1} ) ] + [ \text{} {\sum }_{i = 20}^{21} {c}_{i} \text{} {g}_{i} ] \text{} + [ \text{} {c}_{22} Clip ( {\tilde{R}}_{1} - R ) + {\sum }_{i = 23}^{23 + K} {c}_{i} ( {f}_{i , 0}^{′} + {f}_{i , 1}^{′} ) ] . \qquad ( 12 )$$

where f′_{i,j} is the clipped difference between an APS-filtered neighboring sample value and the current sample value before ALF, and K is the number of included APS-filtered neighboring samples.

In some embodiments, the cascade filtering is conditionally used according to the result of the first filter (earliest filter in the cascade). In some embodiments, the cascade filtering is only applied to samples whose sample values are changed by the first filter (i.e., \tilde{R}₁−R≠0). In some embodiments, the cascade filtering is only applied to samples whose sample values are not changed by the first filter (i.e., \tilde{R}₁−R=0). In some embodiments, the cascade filtering is only applied to samples whose sample value changes are greater or smaller than one threshold (i.e., |\tilde{R}₁−R|>Th or |\tilde{R}₁−R|<Th).

In some embodiments, a two-stage ALF is applied to the reconstructed picture. In the first stage, a normal ALF process is performed according to:

$${\tilde{R}}_{1} = R + [ {\sum }_{i = 0}^{19} {c}_{i} ( {f}_{i , 0} + {f}_{i , 1} ) ] + [ {\sum }_{i = 20}^{21} {c}_{i} {g}_{i} ] \qquad ( 13 )$$

While in the second stage, ALF with another set of filters (with coefficients denoted by c′ᵢ) is performed and only applied to the samples changed by the first-stage ALF. In other words:

$${\tilde{R}}_{2} = \{ \begin{matrix}{\tilde{R}}_{1} + [ {\sum }_{i = 0}^{19} {c}_{i}^{′} ( {f}_{i , 0}^{′} + {f}_{i , 1}^{′} ) ] , & if {\tilde{R}}_{1} - R \neq 0 \\ {\tilde{R}}_{1} , & otherwise\end{matrix} \qquad ( 14 )$$

where f′_{i,j} is the clipped difference between a neighboring sample and current sample after the first-stage ALF filtering. In another embodiment, a threshold Th is set to determine whether to apply the second-stage ALF or not for each sample, specifically,

$${\tilde{R}}_{2} = \{ \begin{matrix}{\tilde{R}}_{1} + [ {\sum }_{i = 0}^{19} {c}_{i}^{′} ( {f}_{i , 0}^{′} + {f}_{i , 1}^{′} ) ] , & if \vert {\tilde{R}}_{1} - R \vert > Th \\ {\tilde{R}}_{1} , & otherwise\end{matrix} \qquad ( 15 )$$

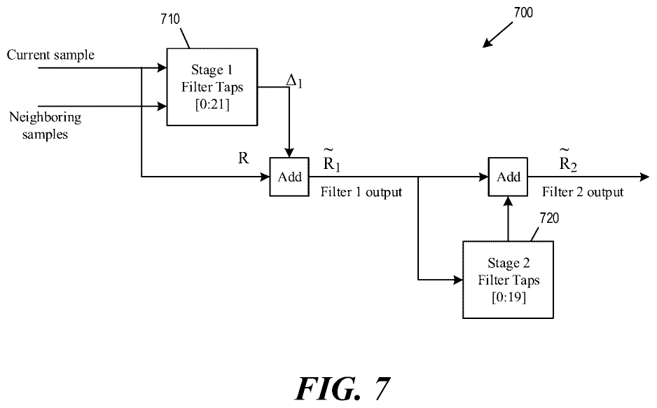

FIG. 7 conceptually illustrates a two-stage ALF 700, in which the filter coefficients of the first stage are different from the filter coefficients of the second stage. The two-stage ALF includes a stage 1 filtering taps module 710 and a stage 2 filtering taps module 720. The tap inputs of the stage 2 filtering taps module 720 may be current and neighboring samples after filtering by the first filter 710. The filter coefficients of the filtering taps 710 are different than the filter coefficients of the filtering taps 720. The two-stage ALF 700 implements conditional filtering for the second stage according to Eq. (15). Specifically, when the \tilde{R}₁−R (or the output of the first filtering stage 710) is 0 or is less than a threshold, the second filter stage 720 outputs a zero or is inactive, such that \tilde{R}₂=\tilde{R}₁.

One difference between cascade filtering and two-stage ALF is whether the result of the first filter \tilde{R}₁ is clipped into a valid range determined by bit-depth or not. For example, if the input bit-depth is 10-bit, in two-stage ALF methods, \tilde{R}₁ is clipped into [0, 1023] after the first-stage ALF, and fed into the second-stage ALF for filtering. But in cascade filtering methods, \tilde{R}₁ is allowed to exceed the range and fed into the second filter as input.

The foregoing proposed methods can be implemented in encoders and/or decoders. For example, the proposed method can be implemented in an in-loop filtering module of an encoder, and/or an in-loop filtering module of a decoder.

### V. Example Video Encoder

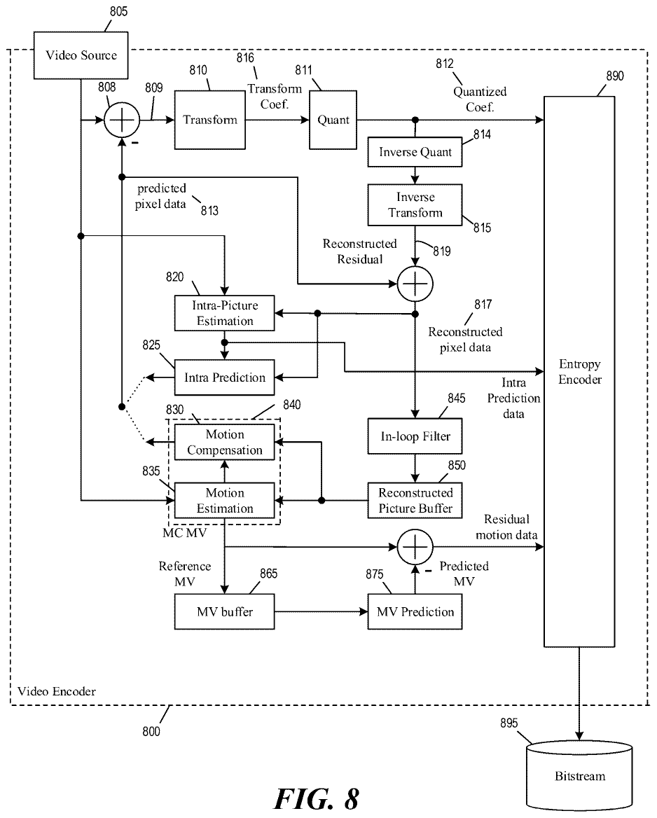

FIG. 8 illustrates an example video encoder 800 that implements adaptive loop filter (ALF). As illustrated, the video encoder 800 receives input video signal from a video source 805 and encodes the signal into bitstream 895. The video encoder 800 has several components or modules for encoding the signal from the video source 805, at least including some components selected from a transform module 810, a quantization module 811, an inverse quantization module 814, an inverse transform module 815, an intra-picture estimation module 820, an intra-prediction module 825, a motion compensation module 830, a motion estimation module 835, an in-loop filter 845, a reconstructed picture buffer 850, a MV buffer 865, and a MV prediction module 875, and an entropy encoder 890. The motion compensation module 830 and the motion estimation module 835 are part of an inter-prediction module 840.

In some embodiments, the modules 810-890 are modules of software instructions being executed by one or more processing units (e.g., a processor) of a computing device or electronic apparatus. In some embodiments, the modules 810-890 are modules of hardware circuits implemented by one or more integrated circuits (ICs) of an electronic apparatus. Though the modules 810-890 are illustrated as being separate modules, some of the modules can be combined into a single module.

The video source 805 provides a raw video signal that presents pixel data of each video frame without compression. A subtractor 808 computes the difference between the raw video pixel data of the video source 805 and the predicted pixel data 813 from the motion compensation module 830 or intra-prediction module 825 as prediction residual 809. The transform module 810 converts the difference (or the residual pixel data or residual signal 808) into transform coefficients (e.g., by performing Discrete Cosine Transform, or DCT). The quantization module 811 quantizes the transform coefficients into quantized data (or quantized coefficients) 812, which is encoded into the bitstream 895 by the entropy encoder 890.

The inverse quantization module 814 de-quantizes the quantized data (or quantized coefficients) 812 to obtain transform coefficients, and the inverse transform module 815 performs inverse transform on the transform coefficients to produce reconstructed residual 819. The reconstructed residual 819 is added with the predicted pixel data 813 to produce reconstructed pixel data 817. In some embodiments, the reconstructed pixel data 817 is temporarily stored in a line buffer (not illustrated) for intra-picture prediction and spatial MV prediction. The reconstructed pixels are filtered by the in-loop filter 845 and stored in the reconstructed picture buffer 850. In some embodiments, the reconstructed picture buffer 850 is a storage external to the video encoder 800. In some embodiments, the reconstructed picture buffer 850 is a storage internal to the video encoder 800.

The intra-picture estimation module 820 performs intra-prediction based on the reconstructed pixel data 817 to produce intra prediction data. The intra-prediction data is provided to the entropy encoder 890 to be encoded into bitstream 895. The intra-prediction data is also used by the intra-prediction module 825 to produce the predicted pixel data 813.

The motion estimation module 835 performs inter-prediction by producing MVs to reference pixel data of previously decoded frames stored in the reconstructed picture buffer 850. These MVs are provided to the motion compensation module 830 to produce predicted pixel data.

Instead of encoding the complete actual MVs in the bitstream, the video encoder 800 uses MV prediction to generate predicted MVs, and the difference between the MVs used for motion compensation and the predicted MVs is encoded as residual motion data and stored in the bitstream 895.

The MV prediction module 875 generates the predicted MVs based on reference MVs that were generated for encoding previously video frames, i.e., the motion compensation MVs that were used to perform motion compensation. The MV prediction module 875 retrieves reference MVs from previous video frames from the MV buffer 865. The video encoder 800 stores the MVs generated for the current video frame in the MV buffer 865 as reference MVs for generating predicted MVs.

The MV prediction module 875 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 895 by the entropy encoder 890.

The entropy encoder 890 encodes various parameters and data into the bitstream 895 by using entropy-coding techniques such as context-adaptive binary arithmetic coding (CABAC) or Huffman encoding. The entropy encoder 890 encodes various header elements, flags, along with the quantized transform coefficients 812, and the residual motion data as syntax elements into the bitstream 895. The bitstream 895 is in turn stored in a storage device or transmitted to a decoder over a communications medium such as a network.

The in-loop filter 845 performs filtering or smoothing operations on the reconstructed pixel data 817 to reduce the artifacts of coding, particularly at boundaries of pixel blocks. In some embodiments, the filtering or smoothing operations performed by the in-loop filter 845 include deblock filter (DBF), sample adaptive offset (SAO), and/or adaptive loop filter (ALF).

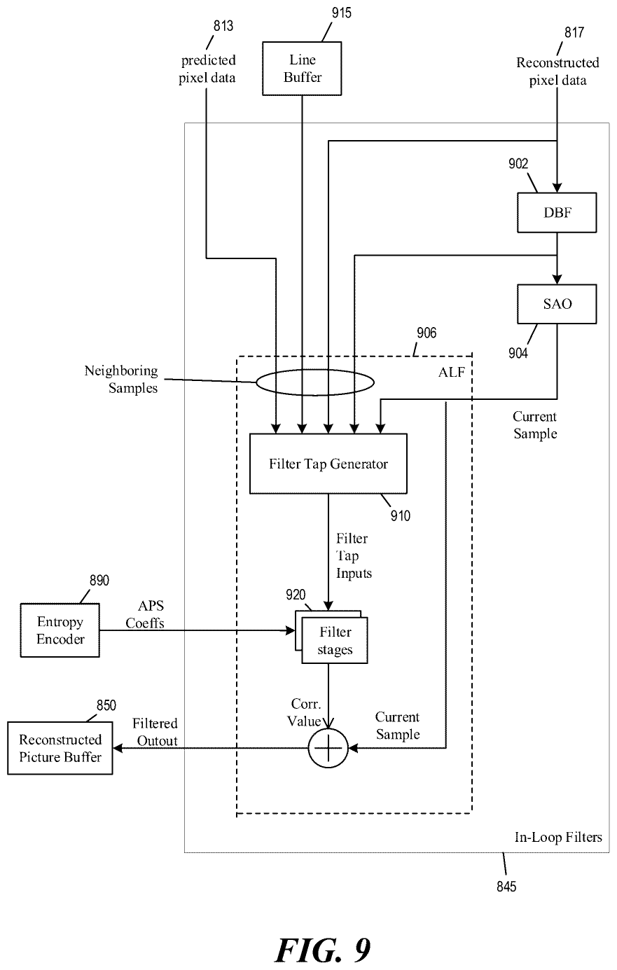

FIG. 9 illustrates portions of the video encoder 800 that implement ALF with multiple stages or cascade filtering. Specifically, the figure illustrates the components of the in-loop filters 845 of the video encoder 800. As illustrated, the in-loop filter 845 receives the reconstructed pixel data 817 of a current block (e.g., current CTB) and produces filtered output to be stored in the reconstructed picture buffer 850. The incoming pixel data are processed in the in-loop filter 845 by a deblock filtering module (DBF) 902 and a sample adaptive offset (SAO) module 904. The processed samples produced by the DBF 902 and the SAO 904 are provided to an adaptive loop filter (ALF) module 906. An example in-loop filter 200 with DBF, SAO, and ALF is described by reference to FIG. 2 above.

The ALF module 906 generates a correction value to be added to a current sample, which is provided by the SAO module 904. The correction value is generated by applying a filter 920 to the current sample and samples neighboring the current sample. The filter 920 may be a cascade filter as described by reference to FIGS. 5-6 above, or a multi-stage ALF as described by reference to FIG. 7 above. The filter coefficients of the filter 920 may be signaled in the bitstream in an APS by the entropy encoder 890. The input to the filter taps of the filter 920 are provided by a filter tap generator 910, which provide differences between the current sample and its neighboring samples as inputs to at least some of the filter taps.

The filter tap generator 910 may provide the neighboring samples required by the filter 920 (i.e., filter footprint) from multiple different sources. The multiple sources of samples may include the output of the SAO module 904, the output of the DBF module 902, the reconstructed pixel data 817, which is the input sample data before the DBF. The multiple sources of samples for selection by the filter tap generator 910 may also include the residual samples of the current block (reconstructed residual 819) and the prediction samples of inter- or intra-prediction for the current block (predicted pixel data 813.) In some embodiments, the multiple sources of filter tap inputs may also include samples of neighboring blocks of the current block (provided by the reconstructed picture buffer 850). The multiple sources of samples may also include a line buffer 915, which temporarily stores some of the reconstructed pixel data 817.

Incoming samples to the ALF module 906 are thereby combined with their corresponding correction values to generate the outputs of the ALF module 906, which is also the output of the in-loop filters 845. The output of the in-loop filter 845 is stored in the reconstructed picture buffer 850 for encoding of subsequent blocks.

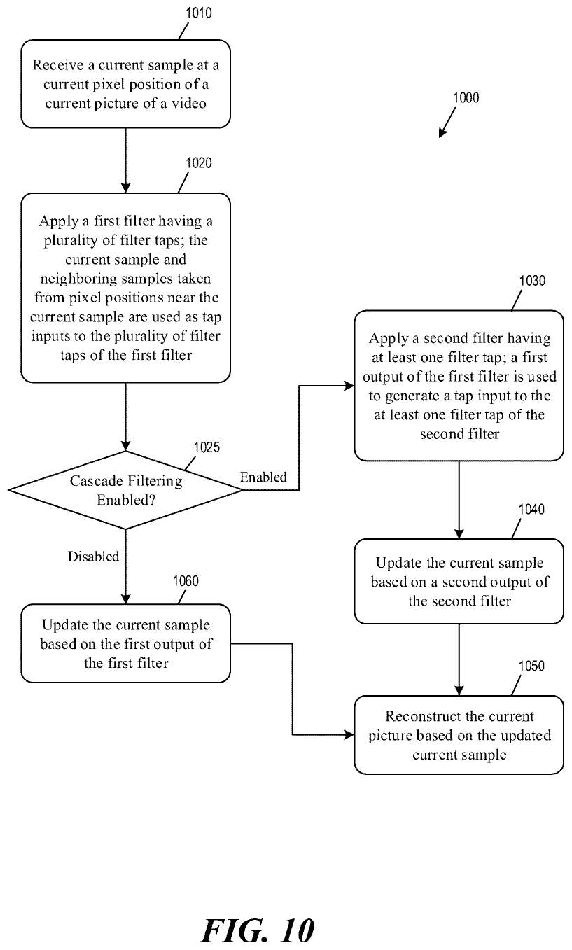

FIG. 10 conceptually illustrates a process 1000 for performing cascade filtering in ALF. In some embodiments, one or more processing units (e.g., a processor) of a computing device implementing the encoder 800 performs the process 1000 by executing instructions stored in a computer readable medium. In some embodiments, an electronic apparatus implementing the encoder 800 performs the process 1000.

The encoder receives (at block 1010) a current sample at a current pixel position of a current picture of a video. The encoder applies (at block 1020) a first filter having a plurality of filter taps. The current sample and neighboring samples taken from pixel positions near the current sample are used as tap inputs to the plurality of filter taps of the first filter. In some embodiments, cascade filtering is always applied, and the process proceeds to block 1030. In some embodiments, cascade filtering is conditional, and the encoder determines (at 1025) whether to enable or disable cascade filtering. In some embodiments, the encoder signals a particular flag for enabling or disabling cascade filtering. In some embodiments, the encoder determines whether to enable or disable cascade filtering based on whether there is a difference or a sufficient difference between the current sample and the first output of the first filter. If cascade filtering is to be enabled, the process proceeds to 1030. If cascade filtering is to be disabled (e.g., |\tilde{R}₁−R|<threshold, \tilde{R}₁−R=0, \tilde{R}₁−R≠0, etc.), the process proceeds to 1060.

The encoder applies (at block 1030) a second filter having at least one filter tap (e.g., C₂₂). A first output (e.g., \tilde{R}₁) of the first filter is used to generate a tap input to the at least one filter tap of the second filter. In some embodiments, the tap input of the at least one filter tap of the second filter is a clipped difference between the first output and the current sample (e.g., c₂₂Clip(\tilde{R}₁−R)). In some embodiments, the second filter includes a plurality of filter taps that use differences between the current sample and the neighboring samples as tap inputs. The plurality of filter taps of the second filter may have filter coefficients that are different than (or the same as) that of the first filter. The encoder updates (at block 1040) the current sample based on a second output (e.g., \tilde{R}₂) of the second filter.

The encoder reconstructs (at block 1050) the current picture based on the updated current sample. For example, the updated current sample may be stored in the reconstructed picture buffer as part of the current picture that can be used as reference to encode subsequent samples or subsequent blocks, in the current picture or subsequent pictures of the video.

In some embodiments, the encoder updates (at block 1060) the current sample based on the first output of the first filter. This is when the second filter is inactive or bypassed when cascade filtering or multi-stage filtering is disabled, so the output of the first filter is used to update the current sample. The process then proceeds to 1050.

### VI. Example Video Decoder

In some embodiments, an encoder may signal (or generate) one or more syntax element in a bitstream, such that a decoder may parse said one or more syntax element from the bitstream.

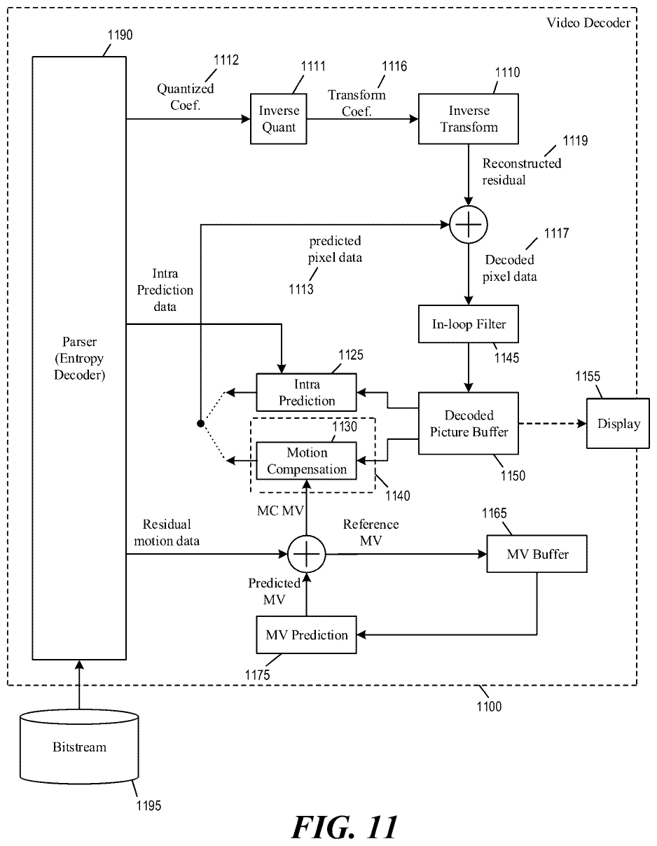

FIG. 11 illustrates an example video decoder 1100 that implement adaptive loop filter (ALF). As illustrated, the video decoder 1100 is an image-decoding or video-decoding circuit that receives a bitstream 1195 and decodes the content of the bitstream into pixel data of video frames for display. The video decoder 1100 has several components or modules for decoding the bitstream 1195, including some components selected from an inverse quantization module 1111, an inverse transform module 1110, an intra-prediction module 1125, a motion compensation module 1130, an in-loop filter 1145, a decoded picture buffer 1150, a MV buffer 1165, a MV prediction module 1175, and a parser 1190. The motion compensation module 1130 is part of an inter-prediction module 1140.

In some embodiments, the modules 1110-1190 are modules of software instructions being executed by one or more processing units (e.g., a processor) of a computing device. In some embodiments, the modules 1110-1190 are modules of hardware circuits implemented by one or more ICs of an electronic apparatus. Though the modules 1110-1190 are illustrated as being separate modules, some of the modules can be combined into a single module.

The parser 1190 (or entropy decoder) receives the bitstream 1195 and performs initial parsing according to the syntax defined by a video-coding or image-coding standard. The parsed syntax element includes various header elements, flags, as well as quantized data (or quantized coefficients) 1112. The parser 1190 parses out the various syntax elements by using entropy-coding techniques such as context-adaptive binary arithmetic coding (CABAC) or Huffman encoding.

The inverse quantization module 1111 de-quantizes the quantized data (or quantized coefficients) 1112 to obtain transform coefficients, and the inverse transform module 1110 performs inverse transform on the transform coefficients 1116 to produce reconstructed residual signal 1119. The reconstructed residual signal 1119 is added with predicted pixel data 1113 from the intra-prediction module 1125 or the motion compensation module 1130 to produce decoded pixel data 1117. The decoded pixels data are filtered by the in-loop filter 1145 and stored in the decoded picture buffer 1150. In some embodiments, the decoded picture buffer 1150 is a storage external to the video decoder 1100. In some embodiments, the decoded picture buffer 1150 is a storage internal to the video decoder 1100.

The intra-prediction module 1125 receives intra-prediction data from bitstream 1195 and according to which, produces the predicted pixel data 1113 from the decoded pixel data 1117 stored in the decoded picture buffer 1150. In some embodiments, the decoded pixel data 1117 is also stored in a line buffer (not illustrated) for intra-picture prediction and spatial MV prediction.

In some embodiments, the content of the decoded picture buffer 1150 is used for display. A display device 1155 either retrieves the content of the decoded picture buffer 1150 for display directly, or retrieves the content of the decoded picture buffer to a display buffer. In some embodiments, the display device receives pixel values from the decoded picture buffer 1150 through a pixel transport.

The motion compensation module 1130 produces predicted pixel data 1113 from the decoded pixel data 1117 stored in the decoded picture buffer 1150 according to motion compensation MVs (MC MVs). These motion compensation MVs are decoded by adding the residual motion data received from the bitstream 1195 with predicted MVs received from the MV prediction module 1175.

The MV prediction module 1175 generates the predicted MVs based on reference MVs that were generated for decoding previous video frames, e.g., the motion compensation MVs that were used to perform motion compensation. The MV prediction module 1175 retrieves the reference MVs of previous video frames from the MV buffer 1165. The video decoder 1100 stores the motion compensation MVs generated for decoding the current video frame in the MV buffer 1165 as reference MVs for producing predicted MVs.

The in-loop filter 1145 performs filtering or smoothing operations on the decoded pixel data 1117 to reduce the artifacts of coding, particularly at boundaries of pixel blocks. In some embodiments, the filtering or smoothing operations performed by the in-loop filter 1145 include deblock filter (DBF), sample adaptive offset (SAO), and/or adaptive loop filter (ALF).

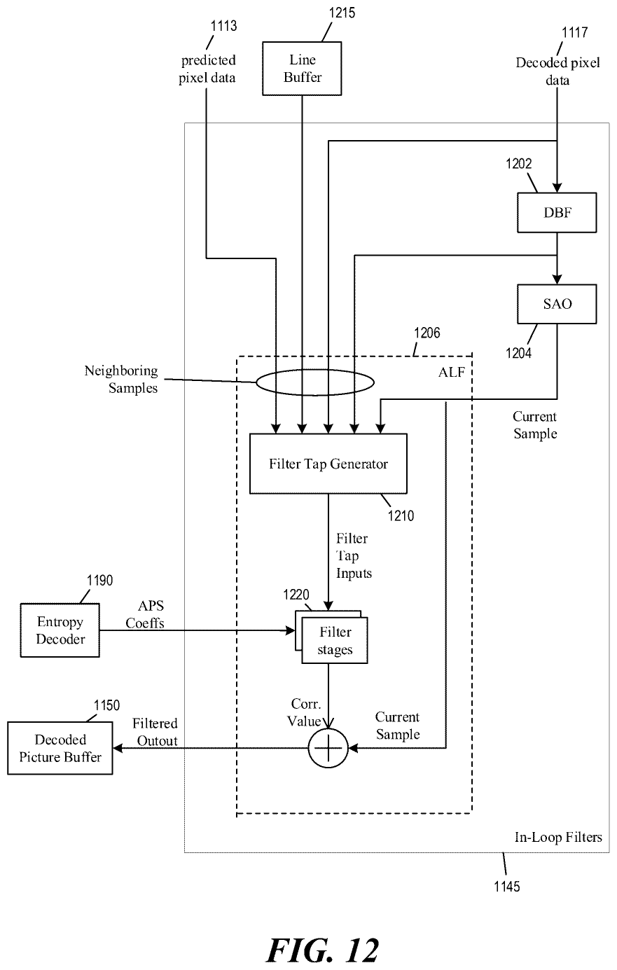

FIG. 12 illustrates portions of the video decoder 1100 that implement ALF with multiple stages or cascade filtering. Specifically, the figure illustrates the components of the in-loop filters 1145 of the video decoder 1100. As illustrated, the in-loop filter 1145 receives the decoded pixel data 1117 of a current block (e.g., current CTB) and produces filtered output to be stored in the decoded picture buffer 1150. The incoming pixel data are processed in the in-loop filter 1145 by a deblock filtering module (DBF) 1202 and a sample adaptive offset (SAO) module 1204. The processed samples produced by the DBF 1202 and the SAO 1204 are provided to an adaptive loop filter (ALF) module 1206. An example in-loop filter 200 with DBF, SAO, and ALF is described by reference to FIG. 2 above.

The ALF module 1206 generates a correction value to be added to a current sample, which is provided by the SAO module 1204. The correction value is generated by applying a filter 1220 to the current sample and samples neighboring the current sample. The filter 1220 may be a cascade filter as described by reference to FIGS. 5-6 above, or a multi-stage ALF as described by reference to FIG. 7 above. The filter coefficients of the filter 1220 may be parsed from the bitstream in an APS by the entropy decoder 1190. The input to the filter taps of the filter 1220 are provided by a filter tap generator 1210, which provide differences between the current sample and its neighboring samples as inputs to at least some of the filter taps.

The filter tap generator 1210 may provide the neighboring samples required by the filter 1220 (i.e., filter footprint) from multiple different sources. The multiple sources of samples may include the output of the SAO module 1204, the output of the DBF module 1202, the decoded pixel data 1117, which is the input sample data before the DBF. The multiple sources of samples for selection by the filter tap generator 1210 may also include the residual samples of the current block and the prediction samples of inter- or intra-prediction for the current block (predicted pixel data 1113.) In some embodiments, the multiple sources of filter tap inputs may also include samples of neighboring blocks of the current block (provided by the decoded picture buffer 1150). The multiple sources of samples may also include a line buffer 1215, which temporarily stores some of the decoded pixel data 1117.

Incoming samples to the ALF module 1206 are thereby combined with their corresponding correction values to generate the outputs of the ALF module 1206, which is also the output of the in-loop filters 1145. The output of the in-loop filter 1145 is stored in the decoded picture buffer 1150 for decoding of subsequent blocks.

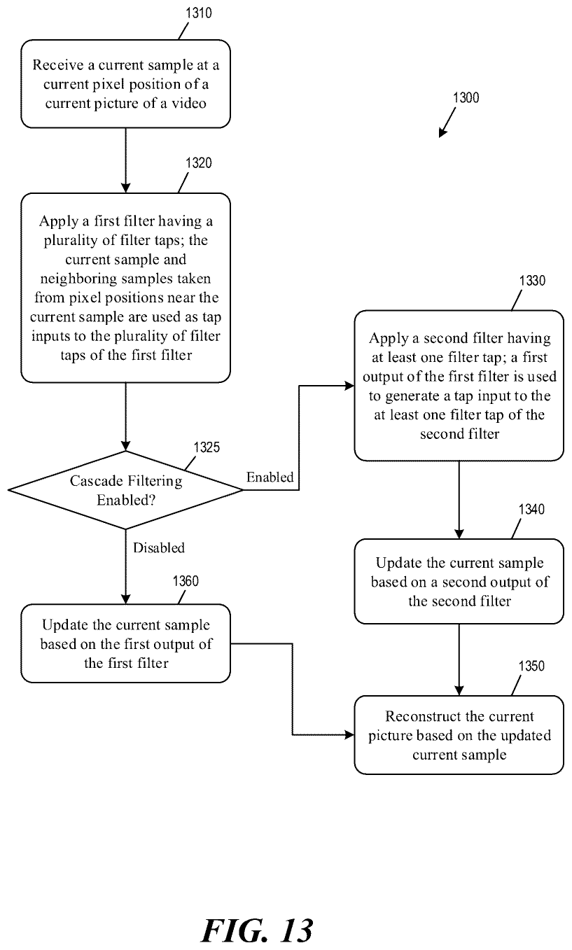

FIG. 13 conceptually illustrates a process 1300 for performing cascade filtering in ALF. In some embodiments, one or more processing units (e.g., a processor) of a computing device implementing the decoder 1100 performs the process 1300 by executing instructions stored in a computer readable medium. In some embodiments, an electronic apparatus implementing the decoder 1100 performs the process 1300.

The decoder receives (at block 1310) a current sample at a current pixel position of a current picture of a video. The decoder applies (at block 1320) a first filter having a plurality of filter taps. The current sample and neighboring samples taken from pixel positions near the current sample are used as tap inputs to the plurality of filter taps of the first filter.

In some embodiments, cascade filtering is always applied, and the process proceeds to block 1330. In some embodiments, cascade filtering is conditional, and the decoder determines (at 1325) whether to enable or disable cascade filtering. In some embodiments, the decoder receives a particular flag for enabling or disabling cascade filtering. In some embodiments, the decoder determines whether to enable or disable cascade filtering based on whether there is a difference or a sufficient difference between the current sample and the first output of the first filter. If cascade filtering is to be enabled, the process proceeds to 1330. If cascade filtering is to be disabled (e.g., |\tilde{R}₁−R|<threshold, \tilde{R}₁−R=0, \tilde{R}₁−R≠0, etc.), the process proceeds to 1360.

The decoder applies (at block 1330) a second filter having at least one filter tap (e.g., C₂₂). A first output (e.g., \tilde{R}₁) of the first filter is used to generate a tap input to the at least one filter tap of the second filter. In some embodiments, the tap input of the at least one filter tap of the second filter is a clipped difference between the first output and the current sample (e.g., c₂₂Clip(\tilde{R}₁−R)). In some embodiments, the second filter includes a plurality of filter taps that use differences between the current sample and the neighboring samples as tap inputs. The plurality of filter taps of the second filter may have filter coefficients that are different than (or the same as) that of the first filter. The decoder updates (at block 1340) the current sample based on a second output (e.g., \tilde{R}₂) of the second filter.

The decoder reconstructs (at block 1350) the current picture based on the updated current sample. For example, the updated current sample may be stored in the reconstructed picture buffer as part of the current picture that can be used as reference to decode subsequent samples or subsequent blocks, in the current picture or subsequent pictures of the video. The decoder may provide the reconstructed current picture for display.

In some embodiments, the decoder updates (at block 1360) the current sample based on the first output of the first filter. This is when the second filter is inactive or bypassed when cascade filtering or multi-stage filtering is disabled, so the output of the first filter is used to update the current sample. The process then proceeds to 1350.

### VII. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

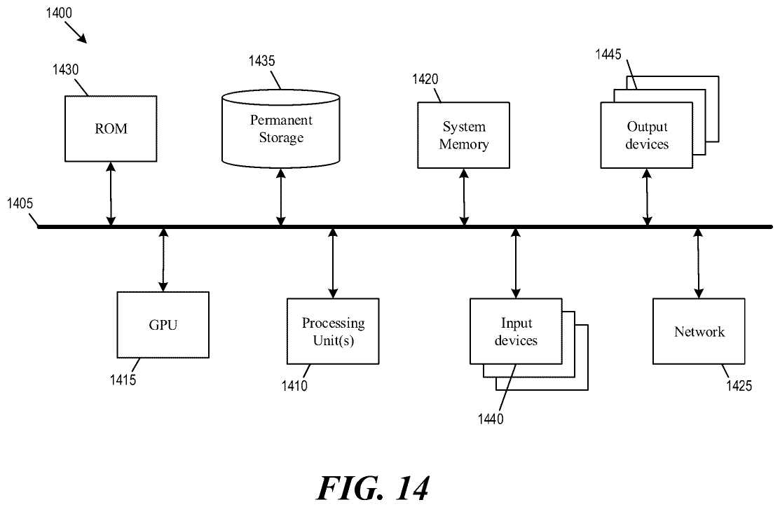

FIG. 14 conceptually illustrates an electronic system 1400 with which some embodiments of the present disclosure are implemented. The electronic system 1400 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1400 includes a bus 1405, processing unit(s) 1410, a graphics-processing unit (GPU) 1415, a system memory 1420, a network 1425, a read-only memory 1430, a permanent storage device 1435, input devices 1440, and output devices 1445.

The bus 1405 collectively represents all system, peripheral, and chipset buses that communicatively connect the numerous internal devices of the electronic system 1400. For instance, the bus 1405 communicatively connects the processing unit(s) 1410 with the GPU 1415, the read-only memory 1430, the system memory 1420, and the permanent storage device 1435.

From these various memory units, the processing unit(s) 1410 retrieves instructions to execute and data to process in order to execute the processes of the present disclosure. The processing unit(s) may be a single processor or a multi-core processor in different embodiments. Some instructions are passed to and executed by the GPU 1415. The GPU 1415 can offload various computations or complement the image processing provided by the processing unit(s) 1410.

The read-only-memory (ROM) 1430 stores static data and instructions that are used by the processing unit(s) 1410 and other modules of the electronic system. The permanent storage device 1435, on the other hand, is a read-and-write memory device. This device is a non-volatile memory unit that stores instructions and data even when the electronic system 1400 is off. Some embodiments of the present disclosure use a mass-storage device (such as a magnetic or optical disk and its corresponding disk drive) as the permanent storage device 1435.

Other embodiments use a removable storage device (such as a floppy disk, flash memory device, etc., and its corresponding disk drive) as the permanent storage device. Like the permanent storage device 1435, the system memory 1420 is a read-and-write memory device. However, unlike storage device 1435, the system memory 1420 is a volatile read-and-write memory, such a random access memory. The system memory 1420 stores some of the instructions and data that the processor uses at runtime. In some embodiments, processes in accordance with the present disclosure are stored in the system memory 1420, the permanent storage device 1435, and/or the read-only memory 1430. For example, the various memory units include instructions for processing multimedia clips in accordance with some embodiments. From these various memory units, the processing unit(s) 1410 retrieves instructions to execute and data to process in order to execute the processes of some embodiments.

The bus 1405 also connects to the input and output devices 1440 and 1445. The input devices 1440 enable the user to communicate information and select commands to the electronic system. The input devices 1440 include alphanumeric keyboards and pointing devices (also called “cursor control devices”), cameras (e.g., webcams), microphones or similar devices for receiving voice commands, etc. The output devices 1445 display images generated by the electronic system or otherwise output data. The output devices 1445 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 14, bus 1405 also couples electronic system 1400 to a network 1425 through a network adapter (not shown). In this manner, the computer can be a part of a network of computers (such as a local area network (“LAN”), a wide area network (“WAN”), or an Intranet, or a network of networks, such as the Internet. Any or all components of electronic system 1400 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 10 and FIG. 13) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video coding method comprising:
receiving a current sample at a current pixel position of a current picture of a video;
applying a first filter comprising a plurality of filter taps, wherein the current sample and neighboring samples taken from pixel positions near the current sample are used as tap inputs to the plurality of filter taps of the first filter;
applying a second filter comprising at least one filter tap, wherein a first output of the first filter is used to generate a tap input to the at least one filter tap of the second filter;
updating the current sample based on a second output of the second filter; and
reconstructing the current picture based on the updated current sample.

2. The video coding method of claim 1, further comprising:
receiving or signaling a particular flag for enabling or disabling cascade filtering;
when the particular flag enables cascade filtering, the output of the second filter is used to update the current sample; and
when the particular flag disables cascade filtering, the output of the first filter is used to update the current sample.

3. The video coding method of claim 1, wherein the second filter is applied only when a difference between the current sample and the first output of the first filter is not zero.

4. The video coding method of claim 1, wherein the second filter is applied only when a difference between the current sample and the first output of the first filter is zero.

5. The video coding method of claim 1, wherein the second filter is applied only when a difference between the current sample and the first output of the first filter is greater than a threshold.

6. The video coding method of claim 1, wherein the second filter is applied only when a difference between the current sample and the first output of the first filter is less than a threshold.

7. The video coding method of claim 1, wherein the tap input of the at least one filter tap of the second filter is a clipped difference between the first output and the current sample.

8. The video coding method of claim 1, wherein the second filter further comprises a plurality of filter taps that use differences between the current sample and the neighboring samples as tap inputs.

9. The video coding method of claim 8, wherein the plurality of filter taps of the second filter has filter coefficients that are different than that of the first filter.

10. The video coding method of claim 1, wherein the current and neighboring samples used as tap inputs for the second filter are after filtering by the first filter.

11. The video coding method of claim 1, wherein the plurality of filter taps of the first filter use differences between the current sample and the neighboring samples as tap input.

12. The video coding method of claim 1, wherein the first and second filters are part of an adaptive loop filter (ALF) of a video coding system in which the filtered sample of the current block is provided for coding subsequent blocks of the current picture.

13. An electronic apparatus comprising:
a video coder circuit configured to perform operations comprising:
receiving a current sample at a current pixel position of a current picture of a video;
applying a first filter comprising a plurality of filter taps, wherein the current sample and neighboring samples taken from pixel positions near the current sample are used as tap inputs to the plurality of filter taps of the first filter;
applying a second filter comprising at least one filter tap, wherein a first output of the first filter is used to generate a tap input to the at least one filter tap of the second filter;
updating the current sample based on a second output of the second filter; and
reconstructing the current picture based on the updated current sample.
